(19) United States
(12) Patent Application Publication
(10) Pub. No.: US 2012/0080286 A1
(43) Pub. Date: Apr. 5, 2012

(54) Vehicle Drive Device

(75) Inventors: Satoru Kasuya, Nishio (JP); Masashi Kitou, Anjo (JP); Yuichi Seki, Okazaki (JP); Yusuke Takahashi, Anjo (JP); Shigeru Sugisaka, Nishio (JP)

(73) Assignee: AISIN AW CO., LTD., Anjo-shi (JP)

(21) Appl. No.: 13/137,869

(22) Filed: Sep. 20, 2011

(30) Foreign Application Priority Data
Sep. 24, 2010 (JP) 2010-213447
Feb. 28, 2011 (JP) 2011-043269

(51) Int. Cl. F16D 13/72

(52) U.S. Cl. 192/113.3; 903/912

(57) ABSTRACT

A vehicle drive device configured with an input member drivably coupled to an internal combustion engine, an output member drivably coupled to wheels, and a friction engagement device that selectively drivably couples the input member and the output member to each other. A rotary electric machine is connected between the input member and the output member. A housing oil chamber houses at least friction members of the friction engagement device and is filled with oil. A housing space houses the rotary electric machine, a first oil passage through which oil is supplied to the housing oil chamber, a second oil passage through which oil is discharged from the housing oil chamber; and a third oil passage through which oil discharged from the second oil passage is supplied to the housing space.

The disclosure of Japanese Patent Applications No. 2011-043269 filed on Feb. 28, 2011 and No. 2010-213447 filed on Sep. 24, 2010 including the specification, drawings and abstract is incorporated herein by reference in its entirety.

### BACKGROUND OF THE INVENTION

The present invention relates to a vehicle drive device including an input member drivably coupled to an internal combustion engine, an output member drivably coupled to wheels, a friction engagement device that selectively drivably couples the input member and the output member to each other, and a rotary electric machine provided on a power transfer path connecting between the input member and the output member.

### DESCRIPTION OF THE RELATED ART

A device disclosed in Japanese Patent Application Publication No. JP-A-2009-72052 mentioned below is already known as an example of the vehicle drive device described above. Hereinafter, in the description in the “Description of the Related Art” section, reference numerals used in JP-A-2009-72052 (and the names of corresponding members as necessary) are cited in brackets for description. In the vehicle drive device, as shown in FIG. 3 of JP-A-2009-72052, oil having cooled friction members [clutch disks 47 and clutch plates 48] of the friction engagement device [hydraulic clutch C] is supplied to an oil passage [oil passages 38a, 39d, 39b, and 39c] formed inside a rotor [11] of the rotary electric machine [motor generator MG] so that the oil can cool permanent magnets [41] provided in the rotary electric machine when the oil flows through the oil passage. Thereafter, the oil is supplied to coil end portions of the rotary electric machine so that the oil can cool the coil end portions. The coil end portions are also cooled by oil that overflows to detour through the axially outer side of the friction members. This allows both the friction members and the rotary electric machine to be cooled.

In the vehicle drive device according to JP-A-2009-72052, the friction members of the friction engagement device are disposed in a space that is open in the axial direction, and the open space and a housing space that houses the rotary electric machine are formed integrally with each other without any boundary therebetween. In such a configuration, in order to secure sufficient capability to cool the friction members, it is necessary to supply a large amount of oil to the friction members, which requires a large oil pump, however. As a result, not only energy for driving the pump is increased but also the weight of the oil pump itself is increased, which may reduce the energy efficiency.

### SUMMARY OF THE INVENTION

In view of the foregoing, it is desirable to provide a vehicle drive device in which both friction members and a rotary electric machine can be efficiently cooled while suppressing the amount of oil supplied to the friction members to be small.

According to a first aspect of the present invention, a vehicle drive device includes an input member drivably coupled to an internal combustion engine, an output member drivably coupled to wheels, a friction engagement device that selectively drivably couples the input member and the output member to each other, a rotary electric machine provided on a power transfer path connecting between the input member and the output member, a housing oil chamber that houses at least friction members of the friction engagement device and that is filled with oil, a housing space that houses the rotary electric machine, a first oil passage through which oil is supplied to the housing oil chamber, a second oil passage through which oil is discharged from the housing oil chamber, and a third oil passage through which oil discharged from the second oil passage is supplied to the housing space.

The term “drivably coupled” means a state in which two rotary elements are coupled to each other in such a way that allows transfer of a drive force, including a state in which the two rotary elements are coupled to each other so as to rotate together with each other, and a state in which the two rotary elements are coupled to each other via one or two or more transmission members in such a way that allows transfer of a drive force. Examples of such transmission members include various members that transfer rotation at an equal speed or a changed speed, such as a shaft, a gear mechanism, a belt, and a chain. Additional examples of such transmission members include engagement devices that selectively transfer rotation and a drive force, such as a friction clutch and a meshing type clutch.

The term “rotary electric machine” refers to any of a motor (electric motor), a generator (electric generator), and a motor generator that functions both as a motor and as a generator as necessary.

According to the first aspect described above, the housing oil chamber is filled with oil, which is supplied to and discharged from the housing oil chamber through the first oil passage and the second oil passage, respectively. Thus, the friction members can be sufficiently cooled by an amount of oil that may fill at least the housing oil chamber, and the first oil passage. That is, it is only necessary to supply a reduced amount of oil in order to secure sufficient capability to cool the friction members. Accordingly, it is not necessary to increase the size of an oil pump that discharges oil, which makes it possible to suppress a reduction in energy efficiency.

According to the first aspect described above, in addition, oil discharged from the housing oil chamber through the second oil passage can be supplied to the housing space via the third oil passage to cool the rotary electric machine housed in the housing space. That is, the rotary electric machine can be cooled utilizing oil that has cooled the friction members. Thus, also from this point, it is only necessary to supply a reduced amount of oil in order to secure required cooling capability.

Thus, according to the first aspect described above, it is possible to provide a vehicle drive device in which both the friction members and the rotary electric machine can be efficiently cooled while suppressing the amount of oil supplied to the friction members to be small.

Here, according to a second aspect of the present invention, the third oil passage may include an oil supply portion that supplies oil to a coil end portion of a stator of the rotary electric machine from above the stator, an axial oil passage extending in an axial direction from a connection portion at which the third oil passage is connected to the second oil passage, and a radial oil passage extending in a radial direction to communicate between the axial oil passage and the oil supply portion.

According to the second aspect, oil flowing through the axial oil passage, which is connected to the second oil passage via the connection portion, and the radial oil passage, which communicates with the axial oil passage, can be supplied to the oil supply portion. Thereafter, the oil can be supplied via the oil supply portion to the coil end portion of the stator of the rotary electric machine to cool the coil end portion. In this event, the oil is supplied to the coil end portion via the oil supply portion from above the stator, and the supplied oil flows vertically downward along the coil end portion. Accordingly, the entirety of the coil end portion can be effectively cooled.

According to a third aspect of the present invention, the oil supply portion may include a tubular member provided above the stator to extend in the axial direction; and a supply opening portion that opens toward the coil end portion may be provided in the tubular member at a position overlapping the coil end portion as viewed in the radial direction.

The phrase “overlap as viewed in a predetermined direction” as used for the arrangement of two members means that when the viewing direction is determined as the predetermined direction and the viewpoint is moved in directions orthogonal to the viewing direction, the two members are seen as overlapping each other from at least some positions of the viewpoint.

According to the third aspect, a part of the third oil passage can be formed above the stator with a relatively simple configuration utilizing the tubular member with a predetermined opening (supply opening portion). In addition, the supply opening portion is provided in the tubular member, which extends along the axial direction, at a position overlapping the coil end portion as viewed in the radial direction. Thus, oil from the oil supply portion can be appropriately supplied to the coil end portion on both sides of the stator in the axial direction.

According to a fourth aspect of the present invention, the vehicle drive device may further include a case that houses at least the rotary electric machine and the friction engagement device, a rotor support member that supports a rotor of the rotary electric machine and that surrounds the friction engagement device from both sides in the axial direction and from an outer side in the radial direction so that the housing oil chamber is formed inside the rotor support member, and a support bearing that supports the rotor support member with respect to the case in the radial direction. In the vehicle drive device, the third oil passage may include a bearing supply oil passage extending from a connection portion at which the third oil passage is connected to the second oil passage toward the support bearing, and a bearing discharge oil passage through which oil discharged from the support bearing is supplied to the housing space.

According to the fourth aspect, the housing oil chamber filled with oil can be formed inside the rotor support member which supports the rotor of the rotary electric machine. Moreover, the rotor support member can be supported with respect to the case via the support bearing so as to be rotatable.

According to the fourth aspect, in addition, the support bearing can be lubricated utilizing oil flowing through the bearing supply oil passage connected to the second oil passage via the connection portion. Thereafter, the oil can be supplied to the housing space via the bearing discharge oil passage to cool the rotary electric machine housed in the housing space. Thus, the rotary electric machine can be cooled while lubricating the support bearing.

According to a fifth aspect of the present invention, the vehicle drive device may further include a case that houses at least the rotary electric machine and the friction engagement device and that is provided adjacent to the rotary electric machine in the axial direction to extend at least in the radial direction, an oil collection portion provided to a rotor support member that supports a rotor of the rotary electric machine and formed to open radially inward, and a fourth oil passage through which oil is supplied from the oil collection portion to a coil end portion of a stator of the rotary electric machine disposed in the housing space; the third oil passage is provided in the support wall, and includes a third oil passage opening portion that opens toward a side of the rotary electric machine; and the third oil passage opening portion is provided radially inwardly of the oil collection portion.

According to the fifth aspect, the third oil passage is formed in the support wall provided adjacent to the rotary electric machine in the axial direction. Thus, the third oil passage can be formed without requiring any additional member.

According to the fifth aspect, in addition, oil supplied from the third oil passage opening portion of the third oil passage can be collected by the oil collection portion provided to the rotor support member at a location radially outwardly of the third oil passage opening portion. Thereafter, the oil collected by the oil collection portion can be supplied via the fourth oil passage to the coil end portion of the stator of the rotary electric machine disposed in the housing space to efficiently cool the coil end portion.

According to a sixth aspect of the present invention, the vehicle drive device may further include a rotation sensor including a sensor stator fixed to the support wall and a sensor rotor disposed radially outwardly of the sensor stator and fixed to a side surface of the rotor support member on a side of the support wall. In the vehicle drive device, the third oil passage opening portion is provided in a surface of the support wall that abuts against the sensor stator, and an axial through hole that penetrates through the sensor stator in the axial direction is provided in the sensor stator at a position overlapping the third oil passage opening portion as viewed in the axial direction.

According to the sixth aspect, the third oil passage opening portion is formed at the radial position of the sensor stator. Thus, the distance in the radial direction between the third oil passage opening portion and the oil collection portion is relatively shortened. This makes it easy to guide oil from the third oil passage opening portion to the oil collection portion. Further, the third oil passage formed in the support wall is formed to extend to a surface of the support wall that abuts against the sensor stator. Thus, the distance in the axial direction between the third oil passage opening portion and the rotor support member and the oil collection portion provided to the rotor support member is also shortened. This also makes it easy to guide oil from the third oil passage opening portion to the oil collection portion. The axial through hole which penetrates through the sensor stator in the axial direction is provided in the sensor stator at a position overlapping the third oil passage opening portion as viewed in the axial direction. Thus, oil from the third oil passage opening portion can be appropriately guided to the oil collection portion via the axial through hole. Accordingly, oil supplied from the third oil passage can be appropriately guided to the housing space via the oil collection portion and the fourth oil passage to efficiently cool the coil end portion.

According to a seventh aspect of the present invention, the oil collection portion may be formed between the sensor rotor and the rotor support member.

According to the seventh aspect, the oil collection portion can be formed between the sensor rotor of the rotation sensor and the rotor support member utilizing the sensor rotor. In many cases, the vehicle drive device including the rotary electric machine serving as a drive force source for the vehicle is provided with a rotation sensor such as that described above for the purpose of accurately detecting the rotational position of the rotor with respect to the stator of the rotary electric machine. Accordingly, the oil collection portion can be formed without requiring any additional member to suppress an increase in cost.

### BRIEF DESCRIPTION OF THE DRAWINGS

FIG. 1 is a schematic diagram showing a schematic configuration of a drive device according to a first embodiment;

FIG. 2 is a partial cross-sectional view of the drive device;

FIG. 3 is a partial enlarged view of FIG. 2;

FIG. 4 is a partial enlarged view of FIG. 2;

FIG. 5 is a graph showing the effect of cooling a clutch according to the present invention; and

FIG. 6 is a partial cross-sectional view showing a drive device according to a second embodiment.

### DETAILED DESCRIPTION OF THE EMBODIMENTS

### 1. First Embodiment

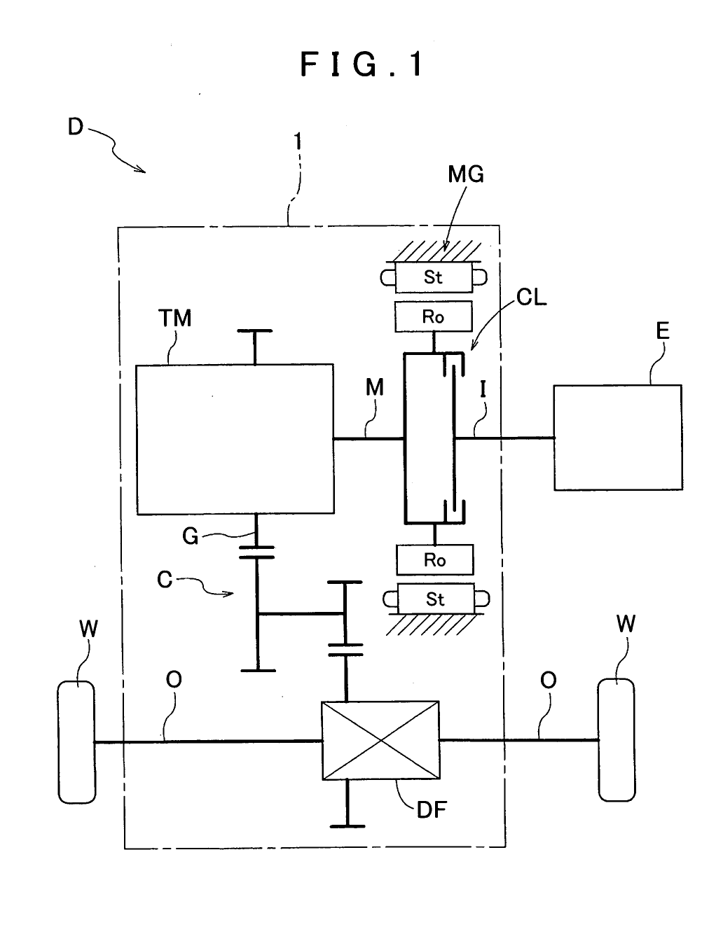

A first embodiment of the present invention will be described with reference to the drawings. FIG. 1 is a schematic diagram showing a schematic configuration of a drive device D according to the embodiment. The drive device D is a drive device (hybrid drive device) for a hybrid vehicle that uses one or both of an internal combustion engine E and a rotary electric machine MG as a drive force source for wheels W of the vehicle. The drive device D is formed as a drive device for a so-called one-motor parallel type hybrid vehicle. The drive device D according to the embodiment will be described in detail below.

1-1. Overall Configuration of Drive Device

As shown in FIG. 1, the drive device D includes an input shaft I drivably coupled to the internal combustion engine E, output shafts O drivably coupled to the wheels W, the rotary electric machine MG a speed change mechanism TM, and an intermediate shaft M drivably coupled the rotary electric machine MG and drivably coupled to the speed change mechanism TM. The drive device D also includes a clutch CL that selectively drivably couples the input shaft I and the output shafts O to each other, a counter gear mechanism C, and an output differential gear device DF. The rotary electric machine MG is provided on a power transfer path connecting between the input shaft I and the output shafts O. In the example, the rotary electric machine MG is drivably coupled to the output shafts O via the intermediate shaft M, the speed change mechanism TM, the counter gear mechanism C, and the output differential gear device DF. These components are housed in a case (drive device case) 1. In the embodiment, the input shaft I functions as the “input member” according to the present invention, and the output shafts O function as the “output member” according to the present invention.

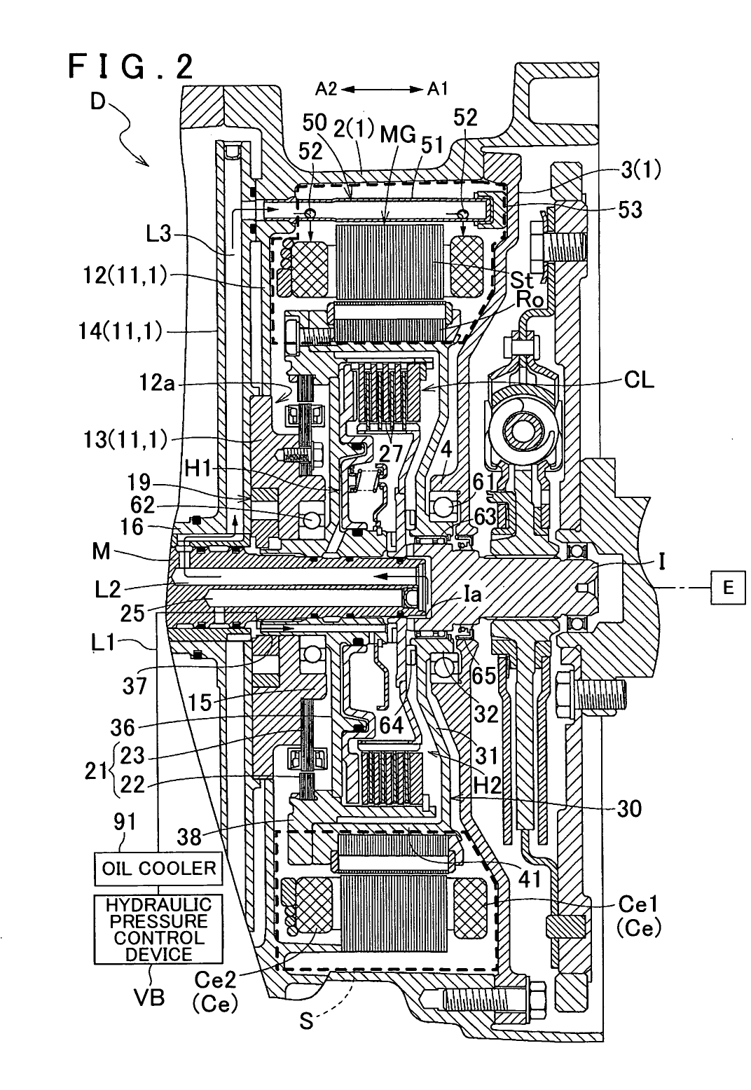

In the embodiment, unless specifically differentiated, the “axial direction”, the “radial direction”, and the “circumferential direction” are defined with reference to the rotational axes of the input shaft I, the intermediate shaft M, and the rotary electric machine MG, which are disposed coaxially with each other. In the embodiment, in addition, the side of the internal combustion engine E with respect to the rotary electric machine MG (right side in FIG. 2) is defined as the side in a first axial direction A1, and the side opposite the internal combustion engine E with respect to the rotary electric machine MG (left side in FIG. 2) is defined as the side in a second axial direction A2. The term “drive force” is used as a synonym for torque.

The internal combustion engine E is a device driven by combusting fuel inside the engine to take out power. A gasoline engine, a diesel engine, or the like may be used as the internal combustion engine E. An output rotary shaft such as a crankshaft of the internal combustion engine E is drivably coupled to the input shaft I. The input shaft I is drivably coupled to the rotary electric machine MG and the intermediate shaft M via the clutch CL. The input shaft I is selectively drivably coupled to the rotary electric machine MG and the intermediate shaft M through the clutch CL. When the clutch CL is in the engaged state, the internal combustion engine E and the rotary electric machine MG are drivably coupled to each other via the input shaft I. When the clutch CL is in the disengaged state, the internal combustion engine E and the rotary electric machine MG are decoupled from each other.

The rotary electric machine MG includes a stator St and a rotor Ro, and can function both as a motor (electric motor) that is supplied with electric power to generate power and as a generator (electric generator) that is supplied with power to generate electric power. Therefore, the rotary electric machine MG is electrically connected to an electricity accumulation device (not shown). A battery, a capacitor, or the like may be used as the electricity accumulation device. The rotary electric machine MG is supplied with electric power from the battery to perform power running, or supplies electric power generated using torque of the internal combustion engine E or an inertial force of the vehicle to the battery to accumulate the electric power. The rotor Ro of the rotary electric machine MG is drivably coupled to the intermediate shaft M so as to rotate together with the intermediate shaft M. The intermediate shaft M serves as an input shaft of the speed change mechanism TM (transmission input shaft).

The speed change mechanism TM is a mechanism that transfers rotation of the intermediate shaft M to the transmission output gear G while changing the rotational speed of the intermediate shaft M with a predetermined speed ratio. In the embodiment, a stepped automatic transmission that switchably provides a plurality of shift speeds with different speed ratios is used as the speed change mechanism TM. An automatic continuously variable transmission with continuously variable speed ratios, a stepped manual transmission that switchably provides a plurality of shift speeds with different speed ratios, or the like may also be used as the speed change mechanism TM. The speed change mechanism TM transfers rotation and torque input to the intermediate shaft M to the transmission output gear G while changing the speed at a predetermined speed ratio at each timing and converting torque.

The transmission output gear G is drivably coupled to the output differential gear device DF via the counter gear mechanism C. The output differential gear device DF is drivably coupled to the wheels W via the output shafts O. The output differential gear device DF splits rotation and torque input to the output differential gear device DF to transfer the split rotation and torque to the two, left and right, wheels W. This allows the drive device D to transfer torque of one or both of the internal combustion engine E and the rotary electric machine MG to the wheels W to run the vehicle.

In the drive device D according to the embodiment, the input shaft I and the intermediate shaft M are disposed coaxially with each other, and the output shafts O are disposed in parallel with each other and non-coaxially with the input shaft I and the intermediate shaft M, forming a multi-axis configuration. Such a configuration is suitable for the drive device D to be mounted on a FF (Front-Engine Front-Drive) vehicle, for example.

1-2. Configuration of Various Components of Drive Device

Next, the configuration of various components of the drive device D according to the embodiment will be described. As shown in FIG. 2, the case 1 houses at least the rotary electric machine MG and the clutch CL. The case 1 includes a case peripheral wall 2 that covers the respective outer peripheries of components housed in the case 1 such as the rotary electric machine MG and the speed change mechanism TM, a first support wall 3 that blocks an opening of the case peripheral wall 2 on the side in the first axial direction A1, and a second support wall 11 provided on the side in the second axial direction A2 with respect to the first support wall 3 and disposed between the rotary electric machine MG and the speed change mechanism TM in the axial direction. The case 1 also includes an end portion support wall (not shown) that blocks an end portion of the case peripheral wall 2 on the side in the second axial direction A2.

The first support wall 3 extends in the radial direction and the circumferential direction on the side in the first axial direction A1 with respect to the rotary electric machine MG and the clutch CL. The first support wall 3 is disposed adjacently with a predetermined clearance on the side in the first axial direction A1 with respect to the rotary electric machine MG and the clutch CL. The first support wall 3 includes a through hole in the axial direction. The input shaft I is inserted through the through hole. This allows the input shaft I to penetrate through the first support wall 3 to be inserted into the case 1. A seal member 65 is disposed between the outer peripheral surface of the input shaft I and the inner peripheral surface of the through hole of the first support wall 3. The first support wall 3 includes a cylindrical projecting portion 4 that projects in the axial direction toward the second axial direction A2. The first support wall 3 rotatably supports a rotor support member 30 through the cylindrical projecting portion 4 on the side in the first axial direction A1 with respect to the rotary electric machine MG.

The second support wall 11 extends in the radial direction and the circumferential direction on the side in the second axial direction A2 with respect to the rotary electric machine MG and the clutch CL. In the embodiment, the second support wall 11 functions as the “support wall” according to the present invention. The second support wall 11 is disposed adjacently with a predetermined clearance on the side in the second axial direction A2 with respect to the rotary electric machine MG and the clutch CL. The case 1 is divided into two case portions, namely a first case portion that houses the rotary electric machine MG, the clutch CL, and so forth and a second case portion that houses the speed change mechanism TM and so forth, with the second support wall 11 serving as the boundary. In the embodiment, the second support wall 11 includes a partition wall 12 formed to extend radially inward from the case peripheral wall 2, and a pump body 13 and a pump cover 14 forming a pump chamber that houses an oil pump 19. A center opening portion 12a is formed in a radially central portion of the partition wall 12. The pump body 13 is inserted through the center opening portion 12a to be disposed radially inwardly of the partition wall 12. The pump cover 14 is disposed in contact with the pump body 13 from the side in the second axial direction A2. The pump cover 14 extends in the radial direction and the circumferential direction. A radially outer end portion of the pump cover 14 is positioned in the vicinity of the inner peripheral surface of the case peripheral wall 2.

The pump body 13 and the pump cover 14 each include a through hole in the axial direction. The intermediate shaft M is inserted through the through holes. This allows the intermediate shaft M to penetrate through the second support wall 11. A cylindrical projecting portion 37 of the rotor support member 30 is inserted between the pump body 13 and the intermediate shaft M, which are disposed coaxially with each other. The pump body 13 includes a cylindrical projecting portion 15 that projects in the axial direction toward the first axial direction A1. The second support wall 11 rotatably supports the rotor support member 30 through the cylindrical projecting portion 15 on the side in the second axial direction A2 with respect to the rotary electric machine MG

The oil pump 19 is housed in the pump chamber formed between the pump body 13 and the pump cover 14. The oil pump 19 is an internal gear pump having an inner rotor and an outer rotor. The inner rotor is spline-connected to the cylindrical projecting portion 37 of the rotor support member 30 so as to rotate together with the cylindrical projecting portion 37. The oil pump 19 sucks oil from an oil pan (not shown) along with rotation of the rotor support member 30, and discharges the sucked oil to supply the oil to the clutch CL, the speed change mechanism TM, the rotary electric machine MG, and so forth. Oil passages are formed inside the pump body 13, the pump cover 14, the intermediate shaft M, and so forth. The oil discharged from the oil pump 19 flows via these oil passages to be supplied to respective portions to which oil is supplied.

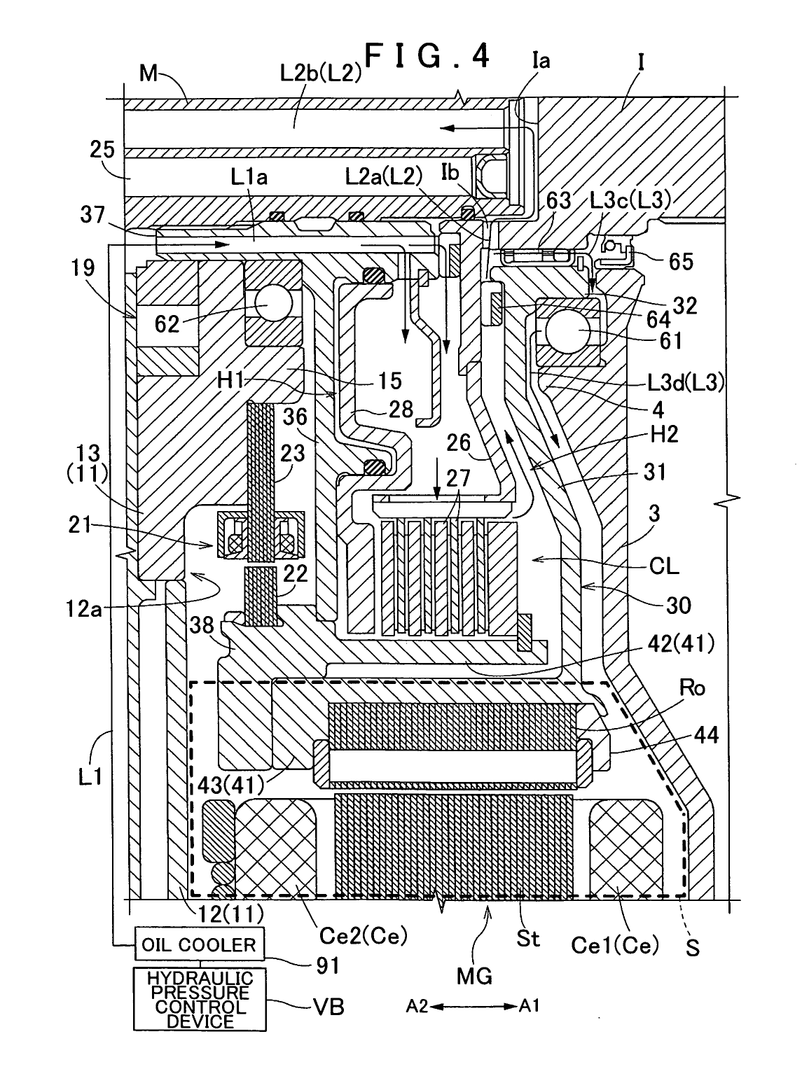

As shown in FIG. 2, the input shaft I, which is disposed to penetrate through the first support wall 3, is drivably coupled to the internal combustion engine E via a damper on the side in the first axial direction A1 with respect to the first support wall 3. A hole portion Ia extending in the axial direction is formed in the radially central portion of an end portion of the input shaft I on the side in the second axial direction A2. As shown in FIG. 4, the inner peripheral surface of the hole portion Ia and the outer peripheral surface of the input shaft I communicate with each other via a discharge through hole Ib extending in the radial direction. The input shaft I is also coupled to a clutch hub 26 via a flange portion formed to extend radially outward at an end portion of the input shaft I on the side in the second axial direction A2.

As shown in FIG. 2, the intermediate shaft M, which is disposed to penetrate through the second support wall 11, is spline-connected to the cylindrical projecting portion 37 of the rotor support member 30. An end portion of the intermediate shaft M on the side in the first axial direction Al is inserted in the axial direction into the hole portion Ia formed in the input shaft I. A working oil passage 25 formed to communicate with a working hydraulic pressure chamber H1 of the clutch CL and a plurality of oil passages including a second oil passage L2 to be discussed later are formed inside the intermediate shaft M.

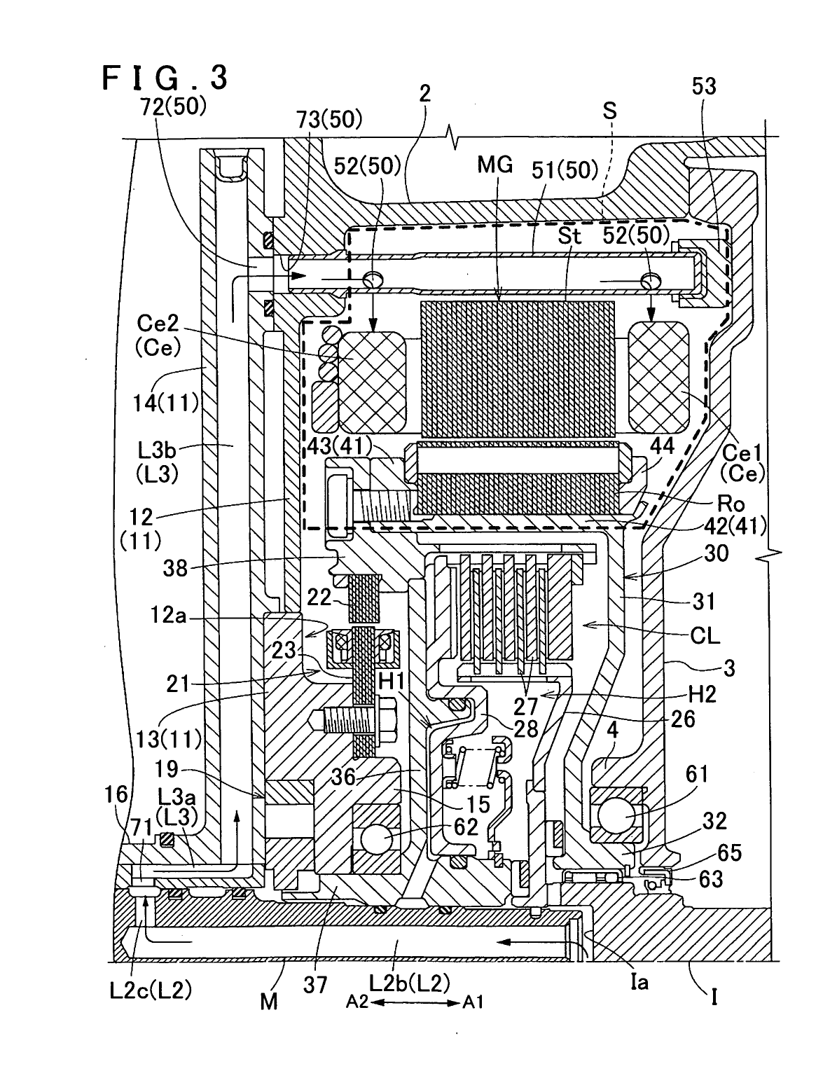

The clutch CL is a friction engagement device provided to switch on and off transfer of a drive force between the input shaft I and the intermediate shaft M and to selectively drivably couple the internal combustion engine E and the rotary electric machine MG to each other. The clutch CL functions to decouple the internal combustion engine E from the rotary electric machine MG and the output shafts O in an electric power travel mode (EV mode) in which only torque of the rotary electric machine MG is utilized to run the vehicle, for example. That is, the clutch CL functions as a friction engagement device that decouples the internal combustion engine. The clutch CL is formed as a wet multi-plate clutch mechanism. As shown in FIG. 3, the clutch CL includes the clutch hub 26, a plurality of friction plates 27, and a piston 28. These components are housed inside the rotor support member 30 formed to cover the peripheries of the components. Thus, in the embodiment, the rotor support member 30 functions as a clutch housing that houses the clutch CL. The rotor support member 30 is configured to also function as a clutch drum. The plurality of friction plates 27 are provided between the rotor support member 30 spline-connected to the intermediate shaft M and the clutch hub 26 integrally coupled to the input shaft I. The piston 28 serving as a pressing member is disposed on the side in the second axial direction A2 with respect to the friction plates 27.

In the embodiment, the working hydraulic pressure chamber H1 which is liquid-tight is formed between the rotor support member 30 and the piston 28. Oil that has been discharged from the oil pump 19 and regulated to a predetermined hydraulic pressure by a hydraulic pressure control device VB is supplied to the working hydraulic pressure chamber H1 via the working oil passage 25 formed inside the intermediate shaft M. Engagement and disengagement of the clutch CL is controlled in accordance with the hydraulic pressure supplied to the working hydraulic pressure chamber H1. A circulation hydraulic pressure chamber H2 is formed on the side opposite the working hydraulic pressure chamber H1 with respect to the piston 28. Oil discharged from the oil pump 19 is supplied to the circulation hydraulic pressure chamber H2 via a first oil passage L1.

As shown in FIG. 2, the rotary electric machine MG is disposed radially outwardly of the clutch CL. The rotary electric machine MG is disposed at a position overlapping the clutch CL as viewed in the radial direction. The stator St of the rotary electric machine MG is fixed to the case 1. The rotor Ro is rotatably supported radially inwardly of the stator St via the rotor support member 30. The stator St includes a cylindrical stator core fixed to the case 1, and a coil wound around the stator core. Portions of the coil that project in the axial direction from end surfaces of the stator core on both sides in the axial direction serve as coil end portions Ce. In the example, the coil end portion on the side in the first axial direction Al is defined as a first coil end portion Ce1, and the coil end portion on the side in the second axial direction A2 is defined as a second coil end portion Ce2.

In the embodiment, the stator St and the rotor Ro of the rotary electric machine MG are housed in a rotary electric machine housing space S. The rotary electric machine housing space S is formed as an annular space formed coaxially with the input shaft I and the intermediate shaft M. In the embodiment, a cross section of the rotary electric machine housing space S taken along a plane including the rotational axis of the input shaft I and the intermediate shaft M occupies a region between the first support wall 3 and the second support wall 11 (here, the partition wall 12) in the axial direction, and occupies a region between a radially inner end surface of the rotor Ro and the case peripheral wall 2 in the radial direction. That is, the rotary electric machine housing space S is a space, of the space inside the first case portion forming the case 1, that is spread radially outwardly of the rotor support member 30. The rotary electric machine housing space S is formed generally along the outer peripheries of the stator St and the rotor Ro so as to surround the peripheries of the stator St and the rotor Ro. A gap between the stator St and the rotor Ro and the case 1 (the first support wall 3, the partition wall 12, and the case peripheral wall 2) is a predetermined distance or less. In FIG. 4, a schematic range occupied by the rotary electric machine housing space S is indicated by the broken line. In the embodiment, the rotary electric machine housing space S functions as the “housing space” according to the present invention.

The rotor support member 30 supports the rotor Ro so as to be rotatable with respect to the case 1. The rotor support member 30 is supported by the first support wall 3 via a first bearing 61 on the side in the first axial direction A1 and by the pump body 13 forming the second support wall 11 via a second bearing 62 on the side in the second axial direction A2, with the rotor Ro fixed to the outer peripheral portion of the rotor support member 30. In addition, the rotor support member 30 is formed to cover the periphery of the clutch CL disposed inside the rotor support member 30. Therefore, the rotor support member 30 includes a first radially extending portion 31 extending in the radial direction on the side in the first axial direction A1 with respect to the clutch CL, a second radially extending portion 36 extending in the radial direction on the side in the second axial direction A2 with respect to the clutch CL, and an axially extending portion 41 extending in the axial direction at a location radially outwardly of the clutch CL.

The first radially extending portion 31 extends in the radial direction and the circumferential direction on the side in the first axial direction A1 with respect to the clutch CL. The first radially extending portion 31 includes a through hole in the axial direction. The input shaft I is inserted through the through hole. This allows the input shaft I to penetrate through the first radially extending portion 31 to be inserted into the rotor support member 30. The first radially extending portion 31 has a uniform thickness as a whole, and is formed in a dish-like shape in which the radially inner portion is positioned slightly on the side in the second axial direction A2 with respect to the radially outer portion. The first radially extending portion 31 also includes a cylindrical projecting portion 32 provided at its radially inner end portion and projecting toward the first axial direction A1. The cylindrical projecting portion 32 is formed to surround the periphery of the input shaft I. A third bearing 63 is disposed between the cylindrical projecting portion 32 and the input shaft I. The first bearing 61 is disposed between the cylindrical projecting portion 32 and the cylindrical projecting portion 4 of the first support wall 3. The first bearing 61 and the third bearing 63 are disposed at positions overlapping each other as viewed in the radial direction. In addition, the first bearing 61 and the third bearing 63 are disposed at positions overlapping the first coil end portion Ce1 as viewed in the radial direction. In the embodiment, the first bearing 61 functions as the “support bearing” according to the present invention.

The second radially extending portion 36 extends in the radial direction and the circumferential direction on the side in the second axial direction A2 with respect to the clutch CL. The second radially extending portion 36 includes a through hole in the axial direction. The intermediate shaft M is inserted through the through hole. This allows the intermediate shaft M to penetrate through the second radially extending portion 36 to be inserted into the rotor support member 30. The second radially extending portion 36 at least partially has a uniform thickness as a whole, and is formed in the shape of a flat plate extending flatly in the radial direction. The second radially extending portion 36 also includes a cylindrical projecting portion 37 provided at its radially inner end portion and projecting toward the second axial direction A2. The cylindrical projecting portion 37 is formed to surround the periphery of the intermediate shaft M. The inner peripheral surface of a part of the cylindrical projecting portion 37 in the axial direction abuts against the outer peripheral surface of the intermediate shaft M over the entire circumference. The second bearing 62 is disposed between the cylindrical projecting portion 37 and the cylindrical projecting portion 15 of the pump body 13.

The cylindrical projecting portion 37 is spline-connected to the intermediate shaft M at the inner peripheral portion of an end portion of the cylindrical projecting portion 37 on the side in the second axial direction A2 so as to rotate together with the intermediate shaft M. The cylindrical projecting portion 37 is also spline-connected to the inner rotor of the oil pump 19 at the outer peripheral portion of an end portion of the cylindrical projecting portion 37 on the side in the second axial direction A2 so as to rotate together with the inner rotor. Thus, the cylindrical projecting portion 37 functions as a pump drive shaft that rotationally drives the inner rotor. The working hydraulic pressure chamber H1 is formed between the second radially extending portion 36 and the piston 28.

In the embodiment, the second radially extending portion 36 includes a sensor attachment portion 38 provided at its radially outer end portion and formed in the shape of a cylinder projecting toward the second axial direction A2 as a whole. In the example, the sensor attachment portion 38 has a predetermined thickness in the axial direction and the radial direction. The radially inner portion of the sensor attachment portion 38 is disposed at a position overlapping the friction plates 27 and the pressing portion of the piston 28 as viewed in the axial direction. In addition, the sensor attachment portion 38 is disposed at a position overlapping the second bearing 62 and the second coil end portion Ce2 as viewed in the radial direction.

The axially extending portion 41 extends in the axial direction and the circumferential direction at a location radially outwardly of the clutch CL. The axially extending portion 41 is formed in a cylindrical shape, and couples the first radially extending portion 31 and the second radially extending portion 36 to each other in the axial direction. In the example, the axially extending portion 41 is formed integrally with the first radially extending portion 31. The axially extending portion 41 is bolted to the second radially extending portion 36. These components may be coupled to each other by welding or the like. The rotor Ro of the rotary electric machine MG is fixed to the outer peripheral portion of the axially extending portion 41.

As shown in FIG. 3, the axially extending portion 41 includes a first support portion 42 that is formed in a cylindrical shape and that supports the rotor Ro from the radially inner side, and a second support portion 43 that is formed in an annular shape and that supports the rotor Ro from the side in the second axial direction A2. The second support portion 43 extends radially outward from an end portion of the first support portion 42 on the side in the second axial direction A2. In the example, the second support portion 43 has a predetermined thickness in the axial direction and the radial direction. An annular rotor holding member 44 is inserted from the side in the first axial direction A1 to be fitted onto the first support portion 42. The rotor holding member 44 holds the rotor Ro from the side in the first axial direction A1.

In the embodiment, a rotation sensor 21 is provided on the side in the second axial direction A2 with respect to the rotor support member 30 and between the pump body 13 forming the second support wall 11 and the second radially extending portion 36. The rotation sensor 21 is a sensor that detects the rotational position of the rotor Ro with respect to the stator St of the rotary electric machine MG. In the example, a resolver is used as the rotation sensor 21. The rotation sensor 21 includes a sensor rotor 22 and a sensor stator 23. The sensor stator 23 is fixed to the pump body 13 at a location radially outwardly of the cylindrical projecting portion 15. The sensor rotor 22 is disposed radially outwardly of the sensor stator 23, and fixed to the sensor attachment portion 38 of the second radially extending portion 36 of the rotor support member 30.

In the embodiment, the rotation sensor 21 is disposed at a position overlapping the second bearing 62 as viewed in the radial direction, at a location radially outwardly of the second bearing 62. In addition, the rotation sensor 21 is disposed at a position overlapping the second coil end portion Ce2 as viewed in the radial direction, at a location radially inwardly of the second coil end portion Ce2. This allows the second bearing 62, the rotation sensor 21, and the second coil end portion Ce2 to be disposed so as to overlap each other as viewed in the radial direction. By adopting such an arrangement relationship, the length of the space occupied by these components in the axial direction is shortened.

1-3. Cooling Structure for Clutch

As shown in FIG. 2, the clutch CL is cooled utilizing a cooling structure mainly formed by the first oil passage L1, the second oil passage L2, and the rotor support member 30. In the embodiment, oil supplied to the circulation hydraulic pressure chamber H2 through the first oil passage L1 cools the plurality of friction plates 27 disposed in the circulation hydraulic pressure chamber H2. After cooling the friction plates 27, the oil is discharged from the circulation hydraulic pressure chamber H2 through the second oil passage L2. In the embodiment, the circulation hydraulic pressure chamber H2 functions as the “housing oil chamber” according to the present invention.

In the embodiment, of the space formed inside the rotor support member 30 which also functions as a clutch housing, most of the space excluding the working hydraulic pressure chamber H1 serves as the circulation hydraulic pressure chamber H2 in which the plurality of friction plates 27 are disposed. As shown in FIG. 4, an axial oil passage L1a extending linearly along the axial direction is formed in the cylindrical projecting portion 37 of the rotor support member 30. The axial oil passage L1a forms a part of the first oil passage L1. An end portion of the axial oil passage L1a on the side in the first axial direction A1 communicates with the inside of the circulation hydraulic pressure chamber H2, and an end portion of the axial oil passage L1a on the side in the second axial direction A2 communicates with the hydraulic pressure control device VB via an oil passage formed in the case 1. Oil that has been discharged from the oil pump 19 and regulated to a predetermined hydraulic pressure by the hydraulic pressure control device VB is supplied to the circulation hydraulic pressure chamber H2 via the first oil passage L1 including the axial oil passage L1a. In the embodiment, an oil cooler 91 is provided in the first oil passage L1 extending from the hydraulic pressure control device VB. Oil from the first oil passage L1 is cooled by the oil cooler 91, and thereafter supplied to the circulation hydraulic pressure chamber H2.

Here, in the embodiment, the third bearing 63 is a bearing with a sealing function (here, a needle bearing with a seal ring) configured to secure a certain degree of liquid tightness. Further, the inner peripheral surface of a part of the cylindrical projecting portion 37 in the axial direction abuts against the outer peripheral surface of the intermediate shaft M over the entire circumference. Therefore, the circulation hydraulic pressure chamber H2 is liquid-tightly sealed, and basically filled with oil at a predetermined pressure or more by being supplied with oil. Thus, in the drive device D according to the embodiment, the plurality of friction plates 27 can be efficiently cooled with a large amount of oil filling the circulation hydraulic pressure chamber H2.

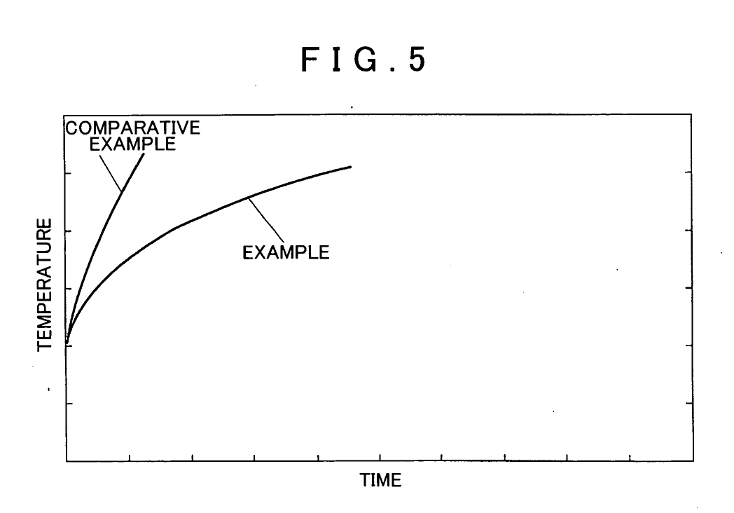

FIG. 5 shows the results of an experiment conducted to verify the effect of cooling the clutch CL in the hybrid drive device D according to the embodiment. Here, variations in temperature of the friction plates 27 over time in the case where the oil pump 19 was driven at a constant rotational speed were measured while controlling an operation of the clutch CL such that the plurality of friction plates 27 slid with respect to each other. In FIG. 5, the curve indicated as “Example” corresponds to data measured with the hybrid drive device D according to the embodiment. Meanwhile, data indicated as “Comparative Example” corresponds to data measured with a drive device in which the inside of the rotor support member 30 which houses the clutch CL is not oil-tightly sealed (in the example, with the first radially extending portion 31 removed). The same conditions were used for both Example and Comparative Example except for the presence or absence of the first radially extending portion 31.

As can be well understood from the graph of FIG. 5, with the drive device according to Comparative Example, the temperature of the friction plates was raised in a relatively short period of time. This is considered to be because oil supplied to the friction plates flowed radially outward through the friction plates so immediately that the entirety of the friction plates could not be sufficiently cooled. With the hybrid drive device D according to Example, in contrast, it is seen that the raise in temperature of the friction plates 27 was suppressed within a predetermined range even after a certain period of time elapsed. This is considered to be because the circulation hydraulic pressure chamber H2 was filled with oil discharged from the oil pump 19 to be supplied to the circulation hydraulic pressure chamber H2 via the hydraulic pressure control device VB and the first oil passage L1 so that the oil in the circulation hydraulic pressure chamber H2 contacted the entirety of the friction plates 27 to efficiently cool the friction plates 27.

With the drive device according to Comparative Example, in order to secure sufficient capability to cool the friction plates, it is necessary to supply a large amount of oil to the friction plates per unit time. For this purpose, however, it is necessary to provide the drive device with a relatively large oil pump. As a result, not only energy for driving the pump is increased but also the weight of the oil pump itself is increased, which may reduce the energy efficiency. In this respect, with the hybrid drive device D according to the embodiment, it is only necessary to supply a relatively small amount of oil in order to secure sufficient capability to cool the friction plates 27. Accordingly, it is not necessary to increase the size of the oil pump 19, which makes it possible to suppress a reduction in energy efficiency.

As shown in FIG. 4, oil having cooled the plurality of friction plates 27 flows radially inward along the first radially extending portion 31, and passes through a fourth bearing 64 disposed between the clutch hub 26 and the first radially extending portion 31 to be discharged from the circulation hydraulic pressure chamber H2. A groove portion in the axial direction and a groove portion in the radial direction are formed in the fourth bearing 64 for communication of oil. The oil having passed through the fourth bearing 64 is guided from the circulation hydraulic pressure chamber H2 to the inside of the intermediate shaft M through an oil discharge passage L2a. Specifically, the oil discharge passage L2a includes an oil passage (gap oil passage) formed in a gap between the clutch hub 26 and the first radially extending portion 31 at a location radially inwardly of the fourth bearing 64, the discharge through hole Ib in the radial direction formed in the input shaft I to open in the outer peripheral surface of the input shaft I, and an oil passage (intershaft oil passage) formed in a gap between the hole portion Ia of the input shaft I and the intermediate shaft M. Oil is guided through these portions into an axial oil passage L2b formed inside the intermediate shaft M.

As shown in FIGS. 3 and 4, the axial oil passage L2b is formed to extend linearly along the axial direction. A radial oil passage L2c extending linearly along the radial direction is formed inside the intermediate shaft M. An end portion of the axial oil passage L2b on the side in the first axial direction A1 communicates with the oil discharge passage L2a. An end portion of the axial oil passage L2b on the side in the second axial direction A2 communicates with the radial oil passage L2c. The radial oil passage L2c opens in the outer peripheral surface of the intermediate shaft M. The opening portion serves as a connection portion at which the second oil passage L2 is connected to a third oil passage L3 (here, an axial oil passage L3a) to be discussed next. In the embodiment, the oil discharge passage L2a, the axial oil passage L2b, and the radial oil passage L2c form the second oil passage L2. These oil passages forming the second oil passage L2 are connected in series in the order in which they are mentioned.

1-4. Cooling Structure for Rotary Electric Machine

As shown in FIGS. 2 and 3, the rotary electric machine MG is cooled utilizing a cooling structure mainly formed by the third oil passage L3 formed above (vertically above) the intermediate shaft M. In the embodiment, oil discharged from the circulation hydraulic pressure chamber H2 through the second oil passage L2 is supplied to the rotary electric machine housing space S through the third oil passage L3 to cool the rotary electric machine MG disposed in the rotary electric machine housing space S.

In the embodiment, the pump cover 14 includes a cylindrical projecting portion 16 that projects from its radially inner end portion toward the second axial direction A2. The cylindrical projecting portion 16 is formed to surround the periphery of the intermediate shaft M. As shown in FIG. 3, a supply communication hole 71 is formed in the cylindrical projecting portion 16 at a position overlapping the radial oil passage L2c as viewed in the radial direction. The supply communication hole 71 extends in the radial direction to communicate with an inner peripheral opening portion formed in the inner peripheral surface of the cylindrical projecting portion 16. In addition, the axial oil passage L3a extending linearly along the axial direction is formed inside the cylindrical projecting portion 16. An end portion of the axial oil passage L3a on the side in the second axial direction A2 communicates with the radial oil passage L2c, which forms the second oil passage L2, via the supply communication hole 71. That is, the axial oil passage L3a is formed to extend in the axial direction from a connection portion at which the third oil passage L3 is connected to the second oil passage L2 (here, a downstream end portion of the second oil passage L2).

A radial oil passage L3b extending linearly along the radial direction is formed in a wall portion of the pump cover 14 extending in the radial direction above the intermediate shaft M. A radially inner end portion of the radial oil passage L3b communicates with an end portion of the axial oil passage L3a on the side in the first axial direction A1. A radially outer end portion of the radial oil passage L3b is positioned further radially outwardly of the outer peripheral surface of the stator St, where the radial oil passage L3b communicates with an oil supply portion 50. That is, the radial oil passage L3b extends in the radial direction to communicate between the axial oil passage L3a and the oil supply portion 50.

A cover communication hole 72 in the axial direction is formed in the pump cover 14. The cover communication hole 72 extends in the axial direction to communicate with an opening portion formed in a surface of the pump cover 14 on the side in the first axial direction A1. The cover communication hole 72 is formed radially outwardly of the outer peripheral surface of the stator St. A partition through hole 73 that penetrates through the partition wall 12 in the axial direction is formed in the partition wall 12 at a position overlapping the cover communication hole 72 as viewed in the axial direction. A cylindrical tubular member 51 extending linearly is inserted into the partition through hole 73 from the side in the first axial direction A1. The outer peripheral surface of the tubular member 51 is fitted with the inner peripheral surface of the partition through hole 73. An end portion of the tubular member 51 on the side in the first axial direction A1 is sealed. The tubular member 51 is fixed with its end portion on the side in the first axial direction A1 supported by a tube support member 53 provided to the first support wall 3. The tubular member 51 thus supported by the partition through hole 73 and the tube support member 53 is disposed to extend linearly along the axial direction above the stator St. In the example, the tubular member 51 is disposed adjacent to the stator St at a location radially outwardly of (above) the stator St.

The tubular member 51 is provided with supply opening portions 52. The supply opening portions 52 are provided to penetrate through the tubular member 51 in the radial direction of the tubular member 51 and to open in the outer peripheral surface of the tubular member 51. In the example, two such supply opening portions 52 are provided at positions overlapping the coil end portions Ce as viewed in the radial direction. That is, one of the two supply opening portions 52 is provided at a position overlapping the first coil end portion Ce1 as viewed in the radial direction, and the other supply opening portion 52 is provided at a position overlapping the second coil end portion Ce2 as viewed in the radial direction. The two supply opening portions 52 thus open toward the coil end portions Ce1 and Ce2 above the coil end portions Ce1 and Ce2.

Oil discharged from the circulation hydraulic pressure chamber H2 through the second oil passage L2 is supplied to the rotary electric machine housing space S through the axial oil passage L3a, the radial oil passage L3b, the cover communication hole 72, the partition through hole 73, the inside of the tubular member 51 (a space defined by the inner peripheral surface), and the supply opening portions 52. The oil introduced into the rotary electric machine housing space S flows vertically downward to be supplied to the coil end portions Ce1 and Ce2 from the radially outer side. In the example, the tubular member 51 is disposed above the stator St, and oil is supplied to the uppermost portions of the coil end portions Ce1 and Ce2 in the vertically direction. That is, in the embodiment, the cover communication hole 72, the partition through hole 73, the tubular member 51, and the supply opening portions 52 form the oil supply portion 50 which supplies oil to the coil end portions Ce1 and Ce2 from above the stator St. In addition, the axial oil passage L3a, the radial oil passage L3b, and the oil supply portion 50 form a part of the third oil passage L3 which supplies oil to the rotary electric machine housing space S.

In the drive device D according to the embodiment, oil is thus supplied to the uppermost portions of the coil end portions Ce from above the stator St via the axial oil passage L3a, the radial oil passage L3b, and the oil supply portion 50 forming the third oil passage L3. The oil supplied to the uppermost portions of the coil end portions Ce flows vertically downward along surfaces of the coil end portions Ce in both circumferential directions. In this event, heat of the coil end portions Ce is transmitted to the oil through heat exchange to cool the coil end portions Ce. In the embodiment, the entirety of the stator St (here, coil end portions Ce, in particular) can be efficiently cooled by the oil supplied to the stator St from above.

As shown in FIG. 4, the oil discharge passage L2a forming the second oil passage L2 includes the gap oil passage discussed above provided between the clutch hub 26 and the first radially extending portion 31 at a location radially inwardly of the fourth bearing 64. In the embodiment, the third bearing 63 is disposed adjacent to the gap oil passage on the side in the first axial direction A1. The third bearing 63 has a certain degree of liquid tightness, but is not completely liquid-tight. A part of oil from the gap oil passage passes between the third bearing 63 and the input shaft I and the cylindrical projecting portion 32 of the first radially extending portion 31 to leak out in the axial direction. The oil having leaked out is dammed by the seal member 65, and flows downward along the first support wall to be supplied to the first bearing 61. That is, in the embodiment, the third oil passage L3 includes a bearing supply oil passage L3c branched from the gap oil passage described above, which serves as a connection portion at which the third oil passage L3 is connected to the second oil passage L2, to extend toward the first bearing 61. Oil having passed through the first bearing 61 while lubricating the first bearing 61 flows vertically downward between the first support wall 3 and the first radially extending portion 31 to be supplied to the rotary electric machine housing space S. That is, the third oil passage L3 includes a bearing discharge oil passage L3d through which oil discharged from the first bearing 61 is supplied to the rotary electric machine housing space S. In the embodiment, the bearing supply oil passage L3c and the bearing discharge oil passage L3d form a part of the third oil passage L3.

The oil supplied to the rotary electric machine housing space S through the bearing supply oil passage L3c and the bearing discharge oil passage L3d after being branched from the second oil passage L2 flows vertically downward, or alternatively is injected radially outward along with rotation of the rotor support member 30. This allows the oil to be supplied to the first coil end portion Ce1 from the radially inner side. In the embodiment, the third oil passage L3 thus includes the bearing supply oil passage L3c and the bearing discharge oil passage L3d. Thus, the stator St (here, the first coil end portion Ce1, in particular) can be cooled while lubricating the first bearing 61.

In the drive device D according to the embodiment, as has been described above, oil discharged from the circulation hydraulic pressure chamber H2 through the second oil passage L2 can be supplied to the rotary electric machine housing space S via the third oil passage L3 (including both an oil passage via the tubular member 51 and an oil passage via the first bearing 61) to cool the coil end portions Ce of the stator St housed in the rotary electric machine housing space S. In this event, substantially all of the oil passing through the second oil passage L2 is supplied to the rotary electric machine housing space S through the third oil passage L3. That is, oil for cooling the friction plates 27 and oil for cooling the coil end portions Ce are substantially perfectly commonalized, which makes it possible to cool the coil end portions Ce utilizing oil having cooled the friction plates 27 as it is. Accordingly, in the drive device D according to the embodiment, both the clutch CL and the rotary electric machine MG can be efficiently cooled while suppressing the amount of oil supplied from the oil pump 19 to be small.

### 2. Second Embodiment

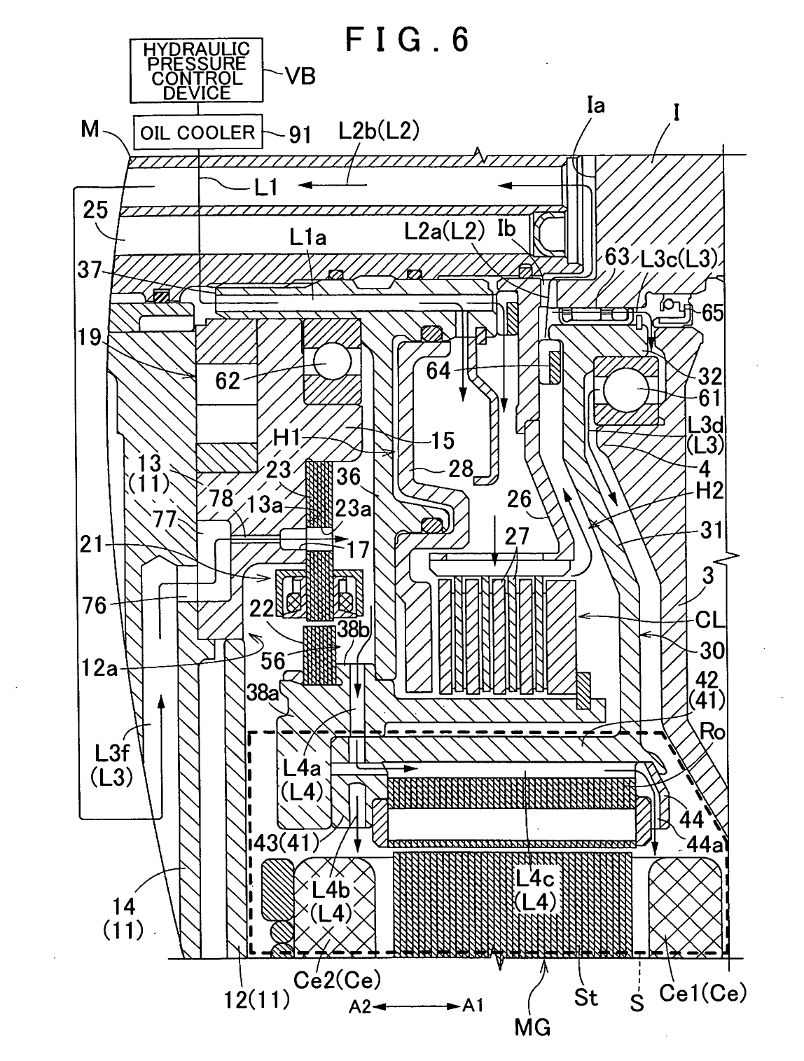

A second embodiment of the present invention will be described with reference to FIG. 6. Also in the embodiment, a vehicle drive device according to the present invention is applied to a drive device D for a hybrid vehicle. The overall configuration of the drive device D according to the embodiment and the configuration of respective components of the drive device D are basically the same as those in the first embodiment described above. It should be noted, however, that the embodiment is different from the first embodiment described above in that the third oil passage L3, which is a main constituent element of the cooling structure for the rotary electric machine MG, is formed below (vertically below) the intermediate shaft M. The differences from the first embodiment will be described below. The same elements as those in the first embodiment described above will not be specifically described.

In the embodiment, the radial oil passage L2c (see FIG. 3) is not formed in the intermediate shaft M, and a downstream end portion of the axial oil passage L2b (in the example, an end portion of the axial oil passage L2b on the side in the second axial direction A2) is connected to a radially outer end portion of a radial oil passage L3f formed to extend in the radial direction inside a wall portion of the pump cover 14 below the intermediate shaft M. The radial oil passage L3f extends linearly along the radial direction to a location radially inwardly of the outer peripheral surface of the pump body 13. A cover communication hole 76 in the axial direction is formed in the pump cover 14. The cover communication hole 76 extends in the axial direction to communicate with an opening portion formed in a surface of the pump cover 14 on the side in the first axial direction A1. A recessed portion 77 that is dented toward the first axial direction A1 is formed in a side surface of the pump body 13 on the side in the second axial direction A2 at a position overlapping the cover communication hole 76 as viewed in the axial direction. The recessed portion 77 communicates via a throttle hole 78 with a third oil passage opening portion 17 that opens toward the first axial direction A1, that is, toward the side of the rotary electric machine MG. In the embodiment, the radial oil passage L3f, the cover communication hole 76, the recessed portion 77, the throttle hole 78, and the third oil passage opening portion 17 form a part of the third oil passage L3. In the embodiment, the oil passage via the tubular member 51 (see FIG. 3) described in relation to the first embodiment described above is not provided.

The third oil passage opening portion 17 is formed to open in a support abutment surface 13a of the pump body 13 provided on the side in the first axial direction A1. That is, the third oil passage opening portion 17 is provided in the support abutment surface 13a of the pump body 13 which abuts against the sensor stator 23. In addition, a supply through hole 23a that penetrates through the sensor stator 23 in the axial direction is provided in the sensor stator 23 at a position overlapping the third oil passage opening portion 17 as viewed in the axial direction: In the embodiment, the supply through hole 23a functions as the “axial through hole” according to the present invention. In the example, the inner diameter of the third oil passage opening portion 17 is set to be larger than the inner diameter of the throttle hole 78, and the inner diameter of the supply through hole 23a is set to be further larger than the inner diameter of the third oil passage opening portion 17.

In the embodiment, an oil collection portion 56 is provided radially outwardly of the third oil passage opening portion 17. The oil collection portion 56 is formed to open radially inward in the second radially extending portion 36 of the rotor support member 30. In the embodiment, the oil collection portion 56 is formed between the second radially extending portion 36 formed in the shape of a flat plate and the sensor rotor 22 disposed in parallel with the second radially extending portion 36.

In the embodiment, a stepped portion is formed on the inner peripheral portion of the sensor attachment portion 38 formed in the shape of a cylinder as a whole. A portion of the sensor attachment portion 38 located on the side in the second axial direction A2 with respect to the stepped portion is formed to be larger in inner diameter than a portion of the sensor attachment portion 38 on the side in the first axial direction A1 with respect to the stepped portion. That is, the sensor attachment portion 38 includes a large-diameter attachment portion 38a and a small-diameter attachment portion 38b formed side by side in the axial direction. The sensor rotor 22 is fixed with its side surface on the side in the first axial direction A1 abutting against a side surface (that is, stepped surface) of the small-diameter attachment portion 38b on the side in the second axial direction A2, and with its radially outer end portion abutting against the inner peripheral surface of the large-diameter attachment portion 38a. In the embodiment, moreover, the oil collection portion 56 is formed as an annular space with a rectangular cross section formed between a side surface of the second radially extending portion 36 on the side in the second axial direction A2, the inner peripheral surface of the small-diameter attachment portion 38b forming the sensor attachment portion 38, and a side surface of the sensor rotor 22 on the side in the first axial direction A1. The oil collection portion 56 can efficiently collect and store oil supplied through the third oil passage opening portion 17 and the supply through hole 23a.

As shown in FIG. 6, the drive device D according to the embodiment includes fourth oil passages L4 through which oil collected by the oil collection portion 56 is supplied to the rotary electric machine housing space S. Accordingly, in the embodiment, the third oil passage L3 supplies oil discharged from the circulation hydraulic pressure chamber H2 through the second oil passage L2 to the rotary electric machine housing space S via the fourth oil passages L4. The fourth oil passages L4 are formed at least in the rotor support member 30, and formed to open at locations radially inwardly of the coil end portions Ce1 and Ce1. The fourth oil passages L4 each include a common oil passage L4a and a radial oil passage L4b extending in the radial direction inside the rotor support member 30, and an axial oil passage L4c extending in the axial direction inside the rotor support member 30.

The common oil passage L4a is formed to extend linearly from the oil collection portion 56 along the radial direction in the sensor attachment portion 38 (here, the small-diameter attachment portion 38b) of the second radially extending portion 36. In the example, a plurality of (for example, eight) common oil passages L4a are disposed to be distributed at equal intervals in the circumferential direction. The common oil passage L4a is also formed to extend linearly along the radial direction in a radially inner portion of the second support portion 43 of the axially extending portion 41. The radial oil passage L4b extends linearly from a radially outer end portion of the common oil passage L4a along the radial direction in a radially outer portion of the second support portion 43 to communicate with the rotary electric machine housing space S. The axial oil passage L4c extends linearly from a radially outer end portion of the common oil passage L4a along the axial direction in the second support portion 43 and the rotor Ro to communicate with the rotary electric machine housing space S. The axial oil passage L4c includes a portion extending in the axial direction inside the second support portion 43, a portion formed between the outer peripheral surface of the axially extending portion 41 and a groove portion of the rotor Ro, and a through hole 44a in the radial direction provided in the rotor holding member 44. In the example, a plurality of (for example, four) radial oil passages L4b and a plurality of (for example, four) axial oil passages L4c are disposed alternately in the circumferential direction.

As has been described above, the oil collection portion 56 communicates with the rotary electric machine housing space S via the fourth oil passages L4. In the embodiment, the axial oil passage L4c branched from the common oil passage L4a to extend in the axial direction is formed to open at a location radially inwardly of the first coil end portion Ce1. An opening portion of the axial oil passage L4c on the side of the rotary electric machine housing space S (an opening portion on the radially outer side of the through hole 44a of the rotor holding member 44) is formed at a position overlapping the first coil end portion Ce1 as viewed in the radial direction. Meanwhile, the radial oil passage L4b branched from the common oil passage L4a to extend in the radial direction is formed to open at a location radially inwardly of the second coil end portion Ce2. An opening portion of the radial oil passage L4b on the side of the rotary electric machine housing space S is formed at a position overlapping the second coil end portion Ce2 as viewed in the radial direction. The fourth oil passages L4 supply oil from the oil collection portion 56 to the coil end portions Ce1 and Ce2.

In the drive device D according to the embodiment, the coil end portions Ce1 and Ce2 are cooled as follows. First, oil discharged from the circulation hydraulic pressure chamber H2 through the second oil passage L2 is supplied to a space inside the first case portion through the radial oil passage L3f, the cover communication hole 76, the recessed portion 77, the throttle hole 78, the third oil passage opening portion 17, and the supply through hole 23a. Thereafter, the oil is collected by the oil collection portion 56, and passes through the fourth oil passages L4 to be supplied to the coil end portions Ce1 and Ce2 of the stator St housed in the rotary electric machine housing space S. In this event, a part of the oil flowing through the fourth oil passages L4 passes through the axial oil passage L4c to be injected radially from its opening portion on the side in the first axial direction A1 along with rotation of the rotor support member 30, and is supplied to the first coil end portion Ce 1 from the radially inner side to cool the first coil end portion Ce1. Another part of the oil flowing through the fourth oil passages L4 passes through the radial oil passage L4b to be injected radially from its opening portion on the side in the second axial direction A2, and supplied to the second coil end portion Ce2 from the radially inner side to cool the second coil end portion Ce2. After cooling the coil end portions Ce1 and Ce2, the oil is returned to an oil pan (not shown).

Also in the embodiment, as has been described above, substantially all the oil discharged from the circulation hydraulic pressure chamber H2 through the second oil passage L2 is supplied to the rotary electric machine housing space S via the third oil passage L3 (including both an oil passage via the third oil passage opening portion 17 and an oil passage via the first bearing 61) to cool the coil end portions Ce of the stator St housed in the rotary electric machine housing space S. Accordingly, also in the embodiment, both the clutch CL and the rotary electric machine MG can be efficiently cooled while suppressing the amount of oil supplied from the oil pump 19 to be small.

In the embodiment, in addition, the oil collection portion 56 is formed utilizing the sensor rotor 22 of the rotation sensor 21. In many cases, the drive device D including the rotary electric machine MG serving as a drive force source for the vehicle as in the embodiment is provided with the rotation sensor 21 for the purpose of accurately detecting the rotational position of the rotor Ro with respect to the stator St of the rotary electric machine MG. Accordingly, the oil collection portion 56 is formed without requiring any additional member, which contributes to a cost reduction and a reduction in overall size of the drive device D.

### 3. Other Embodiments

Lastly, vehicle drive devices according to other embodiments of the present invention will be described. A configuration disclosed in each of the following embodiments may be applied in combination with a configuration disclosed in any other embodiment unless any contradiction occurs.

(1) In the first embodiment described above, the radial oil passage L2c forming the second oil passage L2 communicates with an end portion of the axial oil passage L3a, which forms the third oil passage L3, on the side in the second axial direction A2. However, the present invention is not limited thereto. That is, in one preferred embodiment of the present invention, the radial oil passage L2c may be configured to communicate with any portion of the axial oil passage L3a other than its end portion on the side in the second axial direction A2, for example. In an alternative preferred embodiment of the present invention, the third oil passage L3 may be not provided with the axial oil passage L3a, and the radial oil passage L2c may be configured to communicate with a radially inner end portion of the radial oil passage L3b forming the third oil passage L3.

(2) In the first embodiment described above, oil from the supply opening portions 52 provided in the tubular member 51 is supplied to the uppermost portions of the coil end portions Ce in the vertical direction. However, the present invention is not limited thereto. That is, it is suitable that oil from the supply opening portions 52 is supplied to at least upper portions of the coil end portions Ce. In one preferred embodiment of the present invention, oil from the supply opening portions 52 may be supplied to a region within a predetermined range in the circumferential direction including the uppermost portions of the coil end portions Ce, for example.

(3) In the first embodiment described above, two supply opening portions 52 are provided in the tubular member 51 at positions overlapping the coil end portions Ce as viewed in the radial direction. However, the present invention is not limited thereto. That is, in one preferred embodiment of the present invention, three or more supply opening portions 52 may be provided in the tubular member 51, for example. In this case, in one preferred embodiment of the present invention, third and additional supply opening portions 52 may be provided in the tubular member 51 at positions overlapping the stator core of the stator St as viewed in the radial direction. Rather, all the supply opening portions 52 may be provided in the tubular member 51 at positions overlapping the stator core as viewed in the radial direction. In an alternative preferred embodiment of the present invention, only one supply opening portion 52 may be provided at a position overlapping only one of the coil end portions Ce1 and Ce2 on both sides in the axial direction as viewed in the radial direction.

(4) In the first embodiment described above, the oil supply portion 50 is configured to include the tubular member 51 including the supply opening portions 52. However, the present invention is not limited thereto. That is, the oil supply portion 50 may be configured not to include such a tubular member 51. In this case, in one preferred embodiment of the present invention, oil supplied to the rotary electric machine housing space S through the cover communication hole 72 and the partition through hole 73 may be injected in the axial direction to reach one or both of the coil end portions Ce1 and Ce2, for example. In such a case, it is also suitable that the inner diameters of the cover communication hole 72 and the partition through hole 73 are reduced, for example, so that oil appropriately reaches the first coil end portion Ce1. In one preferred embodiment of the present invention, a gutter-shaped member that can collect oil supplied through the cover communication hole 72 and the partition through hole 73 may be installed above the stator St in place of the tubular member 51, and the supply opening portions 52 may be provided at predetermined positions of the gutter-shaped member, so that oil is supplied from the supply opening portions 52 to the coil end portions Ce1 and Ce2. In an alternative preferred embodiment of the present invention, an oil passage extending in the axial direction may be formed in the case peripheral wall 2, and the supply opening portions 52 may be provided at predetermined positions in the inner peripheral surface of the case peripheral wall 2, so that oil is supplied from the supply opening portions 52 to the coil end portions Ce1 and Ce2.

(5) In the second embodiment described above, the third oil passage opening portion 17 is provided in the support abutment surface 13a of the pump body 13. However, the present invention is not limited thereto. That is, in one preferred embodiment of the present invention, the third oil passage opening portion 17 may be provided in a portion of the pump body 13 other than the support abutment surface 13a. In this case, the third oil passage opening portion 17 may be provided in a side surface of the cylindrical projecting portion 15 on the side in the first axial direction A1, the outer peripheral surface of the cylindrical projecting portion 15, or the like, for example. In an alternative preferred embodiment of the present invention, the third oil passage opening portion 17 may be provided in a portion of the second support wall 11 other than the pump body 13. In this case, the third oil passage opening portion 17 may be provided in a side surface of the partition wall 12 on the side in the first axial direction A1, for example. In these cases, in the case where the third oil passage opening portion 17 is not covered by the sensor stator 23, the sensor stator 23 may be not provided with the supply through hole 23a.

(6) In the second embodiment described above, only one oil collection portion 56 formed in an annular shape that is continuous in the circumferential direction is provided, and a plurality of fourth oil passages L4 communicate with the single oil collection portion 56. However, the present invention is not limited thereto. That is, in one preferred embodiment of the present invention, oil collection portions 56 that are closed on both sides in the axial direction, both sides in the circumferential direction, and the radially outer side and that are open only on the radially inner side may be disposed at a plurality of locations in the circumferential direction to be distributed at equal intervals, for example. In this case, the number of the oil collection portions 56 may be any number (preferably an even number), and the number of the fourth oil passages L4 (each including the common oil passage L4a, the radial oil passage L4b, and the axial oil passage L4c) may be determined accordingly.

(7) In the second embodiment described above, the oil collection portion 56 is formed between the second radially extending portion 36 and the sensor rotor 22. However, the present invention is not limited thereto. That is, in one preferred embodiment of the present invention, a thin plate member formed in a plate shape may be used in place of the sensor rotor 22, for example, and the oil collection portion 56 may be formed between the second radially extending portion 36 and the thin plate member. In this case, the rotation sensor 21 may be disposed at any position. For example, the rotation sensor 21 may be disposed between the first support wall 3 and the first radially extending portion 31 on the side in the first axial direction A1 with respect to the rotor support member 30.

(8) In the second embodiment described above, the fourth oil passages L4 each include both the radial oil passage L4b and the axial oil passage L4c, and are formed to open at locations radially inwardly of both the first coil end portion Ce1 and the second coil end portion Ce2. However, the present invention is not limited thereto. That is, in one preferred embodiment of the present invention, the fourth oil passages L4 may each include only one of the radial oil passage L4b and the axial oil passage L4c, and are formed to open only at a location radially inwardly of one of the first coil end portion Ce1 and the second coil end portion Ce2, for example.

(9) In the first embodiment described above, the drive device D includes, as the third oil passage L3, only an oil passage via the tubular member 51 and an oil passage via the first bearing 61. In the second embodiment described above, meanwhile, the drive device D includes, as the third oil passage L3, only an oil passage via the third oil passage opening portion 17 and an oil passage via the first bearing 61. However, the present invention is not limited thereto. That is, in one preferred embodiment of the present invention, the drive device D may include, as the third oil passage L3, all of an oil passage via the tubular member 51, an oil passage via the third oil passage opening portion 17, and an oil passage via the first bearing 61. In another preferred embodiment of the present invention, the drive device D may include, as the third oil passage L3, any one or a combination of any two of the three oil passages. In an alternative preferred embodiment of the present invention, the drive device D may further include an oil passage other than those described above as the third oil passage L3 through which oil discharged from the circulation hydraulic pressure chamber H2 through the second oil passage L2 is supplied to the rotary electric machine housing space S.

(10) In the embodiments described above, the drive device D is of a multi-axis configuration which is suitable in the case where the drive device D is mounted on a FF (Front-Engine Front-Drive) vehicle. However, the present invention is not limited thereto. That is, in one preferred embodiment of the present invention, the drive device D may be of a single-axis configuration in which the output shaft of the speed change mechanism TM is disposed coaxially with the input shaft I and the intermediate shaft M and directly drivably coupled to the output differential gear device DF, for example. Such a configuration is suitable in the case where the drive device D is mounted on a FR (Front-Engine Rear-Drive) vehicle.

(11) Also regarding other configurations, the embodiments disclosed herein are illustrative in all respects, and the present invention is not limited thereto. That is, a configuration not disclosed in the claims of the present invention may be modified without departing from the object of the present invention.

The present invention may be suitably applied to a vehicle drive device including an input member drivably coupled to an internal combustion engine, an output member drivably coupled to wheels, a friction engagement device that selectively drivably couples the input member and the output member to each other, and a rotary electric machine provided on a power transfer path connecting between the input member and the output member.

1. A vehicle drive device, comprising:
an input member drivably coupled to an internal combustion engine;
an output member drivably coupled to wheels;
a friction engagement device that selectively drivably couples the input member and the output member to each other;
a rotary electric machine provided on a power transfer path connecting between the input member and the output member;
a housing oil chamber that houses at least friction members of the friction engagement device and that is filled with oil;
a housing space that houses the rotary electric machine;
a first oil passage through which oil is supplied to the housing oil chamber;
a second oil passage through which oil is discharged from the housing oil chamber; and
a third oil passage through which oil discharged from the second oil passage is supplied to the housing space.

2. The vehicle drive device according to claim 1, wherein
the third oil passage includes an oil supply portion that supplies oil to a coil end portion of a stator of the rotary electric machine from above the stator, an axial oil passage extending in an axial direction from a connection portion at which the third oil passage is connected to the second oil passage, and a radial oil passage extending in a radial direction to communicate between the axial oil passage and the oil supply portion.

3. The vehicle drive device according to claim 2, wherein:
the oil supply portion includes a tubular member provided above the stator to extend in the axial direction; and
a supply opening portion that opens toward the coil end portion is provided in the tubular member at a position overlapping the coil end portion as viewed in the radial direction.

4. The vehicle drive device according to claim 1, further comprising:
a case that houses at least the rotary electric machine and the friction engagement device;
a rotor support member that supports a rotor of the rotary electric machine and that surrounds the friction engagement device from both sides in the axial direction and from an outer side in the radial direction so that the housing oil chamber is formed inside the rotor support member; and
a support bearing that supports the rotor support member with respect to the case in the radial direction, wherein
the third oil passage includes a bearing supply oil passage extending from a connection portion at which the third oil passage is connected to the second oil passage toward the support bearing, and a bearing discharge oil passage through which oil discharged from the support bearing is supplied to the housing space.

5. The vehicle drive device according to claim 1, further comprising:
a case that houses at least the rotary electric machine and the friction engagement device and that is provided adjacent to the rotary electric machine in the axial direction to extend at least in the radial direction;
an oil collection portion provided to a rotor support member that supports a rotor of the rotary electric machine and formed to open radially inward; and
a fourth oil passage through which oil is supplied from the oil collection portion to a coil end portion of a stator of the rotary electric machine disposed in the housing space, wherein:
the third oil passage is provided in the support wall, and includes a third oil passage opening portion that opens toward a side of the rotary electric machine; and
the third oil passage opening portion is provided radially inwardly of the oil collection portion.

6. The vehicle drive device according to claim 5, further comprising:
a rotation sensor including a sensor stator fixed to the support wall and a sensor rotor disposed radially outwardly of the sensor stator and fixed to a side surface of the rotor support member on a side of the support wall, wherein:
the third oil passage opening portion is provided in a surface of the support wall that abuts against the sensor stator; and
an axial through hole that penetrates through the sensor stator in the axial direction is provided in the sensor stator at a position overlapping the third oil passage opening portion as viewed in the axial direction.

7. The vehicle drive device according to claim 6, wherein
the oil collection portion is formed between the sensor rotor and the rotor support member.
